(19) United States
(12) Patent Application Publication
(10) Pub. No.: US 2026/0111668 A1
(43) Pub. Date: Apr. 23, 2026

(54) METHOD AND APPARATUS FOR DETERMINING TEXT OUTPUT

(71) Applicant: CANON MEDICAL SYSTEMS CORPORATION, Otawara-shi (JP)

(72) Inventors: Hamish MACKINNON, Edinburgh (GB); Murray CUTFORTH, Edinburgh (GB)

(73) Assignee: CANON MEDICAL SYSTEMS CORPORATION, Otawara-shi (JP)

(21) Appl. No.: 18/918,178

(22) Filed: Oct. 17, 2024

(51) Int. Cl. G06F 40/284; G06F 40/242; G06F 40/247

(52) U.S. Cl. CPC G06F 40/284; G06F 40/242; G06F 40/247

(57) ABSTRACT

An apparatus comprises processing circuitry configured to:
receive input text;
apply a trained model to the input text to determine a sequence of tokens, wherein the sequence of tokens represents a text output,
wherein the trained model is configured to perform a repeating next token selection process comprising selecting a next token in the sequence based on at least one previous token in the sequence,
the next token selection process comprises selecting a plurality of candidate tokens and the processing circuitry is configured to filter the plurality of candidate tokens to exclude one or more of the candidate tokens if they match at least one exclusion criterion.

### FIELD

Embodiments described herein relate generally to a method of, and apparatus for, determining output text based on a text input, for example using natural language processing.

### BACKGROUND

It is known to process data to generate text in a natural language. Text-to-text processing is one instance of Natural language generation (NLG).

Current text generators that employ artificial intelligence or machine learning and process large language models achieve good grammatical quality and style but often fail to be factual. Text generated using NLG techniques can contain hallucinations and omit facts.

Hallucinations or factually incorrect outputs from a text generator may be caused by the pre-training objective of denoising and next token prediction. Little focus may be given to what makes a particular instance of training text different from similar ones.

The above issues may be particularly serious in the context of medical data processing given the potentially serious consequences for a patient of any errors, as well as the possibility of a clinician losing faith in the reliability of a system if it produces hallucinations or other errors.

### BRIEF DESCRIPTION OF THE DRAWINGS

Embodiments are now described, by way of non-limiting example, and are illustrated in the following figures, in which:

FIG. 1 is a schematic diagram of an apparatus according to an embodiment;

FIG. 2 is a flow chart illustrating in overview a method of text generation in accordance with an embodiment;

FIGS. 3 to 6 are schematic illustrations of text generation in accordance with embodiments; and

FIG. 7 is a schematic illustration of text generation in accordance with a further alternative embodiment.

### DETAILED DESCRIPTION

Certain embodiments provide an apparatus comprising processing circuitry configured to:
receive input text;
apply a trained model to the input text to determine a sequence of tokens, wherein the sequence of tokens represents a text output,
wherein the trained model is configured to perform a repeating next token selection process comprising selecting a next token in the sequence based on at least one previous token in the sequence,
the next token selection process comprises selecting a plurality of candidate tokens and the processing circuitry is configured to filter the plurality of candidate tokens to exclude one or more of the candidate tokens if they match at least one exclusion criterion.

Certain embodiments provide a computer-implemented method comprising:
receiving input text;
applying a trained model to the input text to determine a sequence of tokens, wherein the sequence of tokens represents a text output that is generated based on the input text,
wherein the trained model is configured to perform a repeating next token selection process comprising selecting a next token in the sequence based on at least one previous token in the sequence,
the next token selection process comprises selecting a plurality of candidate tokens and the processing circuitry is configured to filter the plurality of candidate tokens to exclude one or more of the candidate tokens if they match at least one exclusion criterion.

It is a feature of certain embodiments that constraints, which may be referred to as guardrails, may be put on text generation at the point where a trained machine learning model chooses an output in response to an input, thus reducing hallucination and factually incorrect outputs. In various embodiments context can be used to choose a token to continue an output sequence. If the scope of content that is expected represented in the input text or input tokens, for instance determined using an encoder, and the scope of all possible content that the system might need to generate as output text, suitable constraints can be put in place to reduce hallucinations or other errors, for example by restricting the vocabulary of a decoder used to generate the output text.

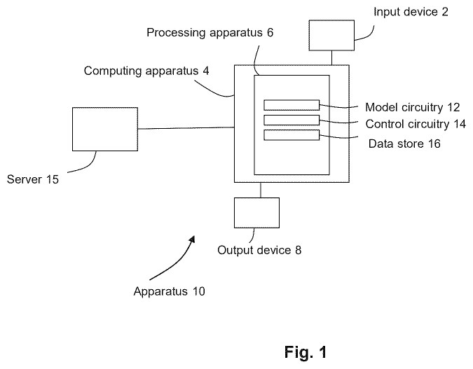

A data processing system 10 according to an embodiment is illustrated schematically in FIG. 1. The data processing system 10 is used for text generation and comprises a computing apparatus 4, in this case a personal computer (PC) or workstation, which is connected to a display screen 8 or other output device, and an input device or devices 2 such as a computer keyboard and mouse.

The computing apparatus 4 is configured to obtain data sets from a data store 16. The data store 16 is shown in FIG. 1 as forming part of the computing apparatus 4, but may be external to the computing apparatus 4. In some embodiments the data store may be remote from the computing apparatus 4 and connected thereto via a network connection or any other suitable communication technique. The data sets may be obtained or generated using any suitable apparatus or from any suitable source.

The data may comprises patient records, or parts of patient records, or for example one or more of text from physician notes, text from a medical record, patient information automatically gathered from a medical record, text manually entered by a physician or other person, or text associated with at least one scan, medical investigation or other medical procedure.

In some embodiments, at least some of the data can include, or can be determined from medical imaging data, for instance obtained using a scanner 4 and may include associated text data. The scanner 4 may be configured to generate medical imaging data, which may comprise two-, three- or four-dimensional data in any imaging modality. For example, the scanner 4 may comprise a magnetic resonance (MR or MRI) scanner, CT (computed tomography) scanner, cone-beam CT scanner, X-ray scanner, ultrasound scanner, PET (positron emission tomography) scanner or SPECT (single photon emission computed tomography) scanner.

The computing apparatus 4 may receive data from one or more further data stores (not shown) instead of or in addition to data store 16. For example, the computing apparatus 2 may receive medical image data from one or more remote data stores (not shown) which may form part of a Picture Archiving and Communication System (PACS) or other information system.

In some embodiments the data may in other formats such as image data, audio data or any combination of text, image and audio data for subsequent pre-processing to obtain text for providing to a trained model of the embodiment

Computing apparatus 4 comprises a processing apparatus 6 for processing of data. The processing apparatus comprises a central processing unit (CPU) and/or Graphical Processing Unit (GPU), and may further comprise a Tensor Processing Unit (TPU). Any other suitable processing circuitry may be used in other embodiments. The processing apparatus 6 provides a processing resource for automatically or semi-automatically processing input text data. In other embodiments, the data to be processed may comprise any form of data, which may include medical image data and medical reports containing a combination of images and text.

The processing apparatus according to the embodiment in FIG. 1 comprises the model circuitry 12, the control circuitry 14 and the data store circuitry 16. The model circuitry 12 provides a trained machine learning model for example a neural network, used to process input text to generate output text. The model circuitry 12 may comprise a trained natural language model. The model circuitry of FIG. 1 comprises a trained neural network encoder-decoder model. In some embodiments the model circuitry 12 downloads the trained model from data store 16 or from a remote data store. In some other embodiments the trained model is stored remotely and the mode circuitry is operable to communicate with the remote trained model, for example to provide input data and instructions to the model and to receive outputs from the model.

One or more transformer networks may be used as the machine leaning model. These consists of a tokenizer, converting words/subwords into a vector embedding (a vector of numbers that represents the internal representation of the word/subword). Transformer layers alternating attention with feedforward layers process the tokens and produces output tokens that are then converted back into words. Attention is another learnt tensor describing how the embedded tokens relate to one another. The attention mechanism can be duplicated, creating a so called multi-headed attention to allow the learning of multiple types of token similarity. BERT/GPT are examples of transformers that may be used.

The trained machine learning model may, alternatively or additionally, be a multimodal generative Large Language Model (LLM) or other language model. Alternatively or additionally, the model may comprise at least one of GPT-2, GPT-3.5, GPT-4, PaLM, LLaMa, BLOOM, Ernie, T5, Claude or Claude 2 or any suitable derivatives or developments thereof. The trained machine learning model may comprise a generative LLM. The LLM may be located on a server 15 remote from the computing apparatus 4 of FIG. 1 in some embodiments. Communication between the computing apparatus 4 and the trained model may be via the internet or any other suitable communication or networking method. In such embodiments, the processing circuitry 36 may provide an application programming interface (API) that is configured to receive prompts or other input, to send the prompts or other input to the LLM or other model, and to receive responses from the LLM or other model.

In other embodiments, the trained model may be stored or implemented locally at the apparatus 22. The trained model may be implemented by the model circuitry 12.

The model circuitry 12 may be used to implement word embedding for finding synonyms of input tokens. In the context of synonym finding, word embeddings can be leveraged to identify words with similar vector representations, indicating similar meanings. To utilize word embeddings, word vectors are generated for specific words and similarity between these vectors is calculated.

The control circuitry 14 is operable to route data between, and control interaction of, the different circuities or modules of the system. The control circuitry is operable to control use of the trained model and the sending of input data to and receipt of output data from the trained model for instance based on user input.

The data store 16 of FIG. 1 is also configured to store a dictionary, knowledge graph or ontology that, for example, may be used to map input tokens to output tokens. Labels that comprise lookup keys to one or more output tokens that are associated with input tokens may be stored in the data store 16 by the control circuitry 14. The data store 16 may also be used to expand a given set of output token to find further output tokens with associations with the set of output tokens. The knowledge graph or ontology in the data store circuitry 16 may be navigable in order to produce context specific sub-graphs that may be used to expand a given set of output tokens as mentioned above. The data store may store a knowledge graph of medical entities.

In the present embodiment, the circuitries 12, 14, 16 are each implemented in the CPU and/or GPU and/or TPU by means of a computer program having computer-readable instructions that are executable to perform the method of the embodiment. In other embodiments, the circuitries may be implemented as one or more ASICs (application specific integrated circuits) or FPGAs (field programmable gate arrays). In the present embodiment, the circuitries 12, 14 and 16 are virtual divisions of the hardware and software in a single computing apparatus 4. In other embodiments, each circuitry may be implemented on a separate computing apparatus.

The computing apparatus 4 also includes a hard drive and other components of a PC including RAM, ROM, a data bus, an operating system including various device drivers, and hardware devices including a graphics card. Such components are not shown in FIG. 1 for clarity.

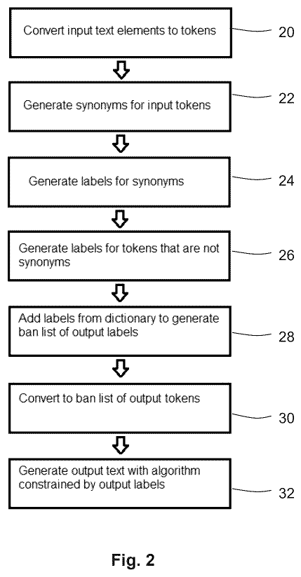

The data processing system 10 of FIG. 1 is configured to perform a method in accordance with FIG. 2. FIG. 2 is a flow chart illustrating in overview a method of text generation in accordance with an embodiment.

In the embodiment of FIG. 1, the first stage 20 of the process is the conversion of input text elements to tokens, or word embeddings. In the embodiment, a token represents a word in a natural language. In other embodiments, a token can comprise paragraphs, sentences, strings, words and elements smaller than words. Each token is represented by a real-valued vector with multiple dimensions, often in the tens or hundreds. Stage 20 outputs a sequence of input tokens representing the input text. The In other embodiments, other subsections of the processing apparatus 6 may be used to implement stage 20.

In stage 22, synonyms are generated for the input tokens from stage 20. Synonyms can be found from word embeddings by identifying words with similar vector representations, indicating similar meanings. Other criteria may be used to assess similarity of meanings. The trained machine learning model from the model circuitry 12 may be used to find synonyms for input tokens. The trained machine learning model may comprise a trained natural language model. The output tokens obtained from the model circuitry 12 are candidate tokens for the output text. Alternatively or additionally, synonyms can be generated in stage 22 by manual selection of text by the user. This may be achieved by the user entering or selecting data using the input device 2.

At stage 24, labels are generated for the synonyms or output tokens obtained in stage 22. These labels comprise the lookup keys to the generated synonyms or output tokens in the data store. The label may for example be a key to a database. For example haemorrhage->haematoma, bleed. Any labels that when expanded through the database/graph does not intersect a label from the input sequence would be “not synonyms” list, which is then expanded through the database/graph to create the ban list in this example.

In stage 26, the labels generated in stage 24 are used to make a list of labels that are not synonyms and/or are not present in the input text. These are also referred to as absent labels.

If the labels to strictly relevant synonyms are part of a universal set and it is desired to find the complement to produce the ban list, the universal set may be taken as being all tokens, for example the whole set of tokens that the network can generate.

In stage 28, the data store is used to add to the list of labels that are not synonyms to generate a list of output labels that are to be precluded from the output message. A knowledge graph of ontology can be added and navigated to produce context specific subgraphs that can be used to extend the list of labels that are not synonyms.

At stage 30, the list of output labels is converted into a list of output tokens that are to be precluded from the output message. This is also referred to as a ban-list of output tokens. Furthermore, the neighboring semantic vector embeddings of the knowledge graph in a vector database may be used to collect candidate tokens for the ban-list of output tokens.

Ban words that would only match inputs that are not present, found with e.g. UMLS or data mining annotated text. There are several ways to expand from a key label. One way is to data-mine and build up a table/database of term relatedness. Expanding the label into ban words would then be simply looking up the related words in that database. An alternative is to traverse a UMLS graph from the key word. By following edges in the UMLS graph indicating a strong relationship, the words can be expanded from a single node (label) into a set of graph nodes and their subsequent label.

At stage 32, the model circuitry 12 generates output text using an algorithm constrained by the ban-list of output tokens.

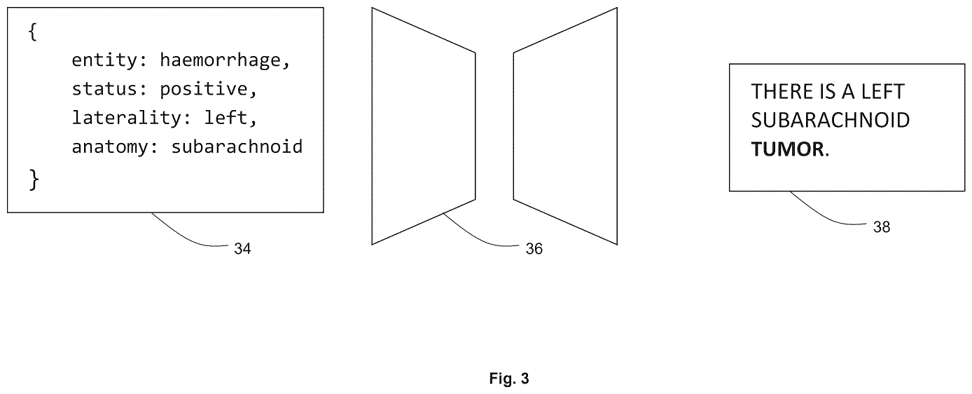

In FIG. 3, according to an embodiment, a text input 34 is provided to a transformer or other type of deep learning architecture that is configured to process text sequences. In the present embodiment, a BART transformer 36 is used to process a text input 34 to obtain a text output 38.

BART is a denoising autoencoder. The input and output are in the form of a text sequence, and the encoder learns a high-dimensional representation of the input, which is then mapped to an output by the decoder. A bidirectional encoder and a left-to-right decoder may be used. BART can represent long-term relationships in a text that extend beyond sequential relationships.

In FIG. 3, the text input 34 comprises the following text: “entity: haemorrhage, status: positive, laterality: left, anatomy: subarachnoid”. The BART transformer 36 processes the text input 34 to generate text output 38 which reads: “there is a left subarachnoid tumor”.

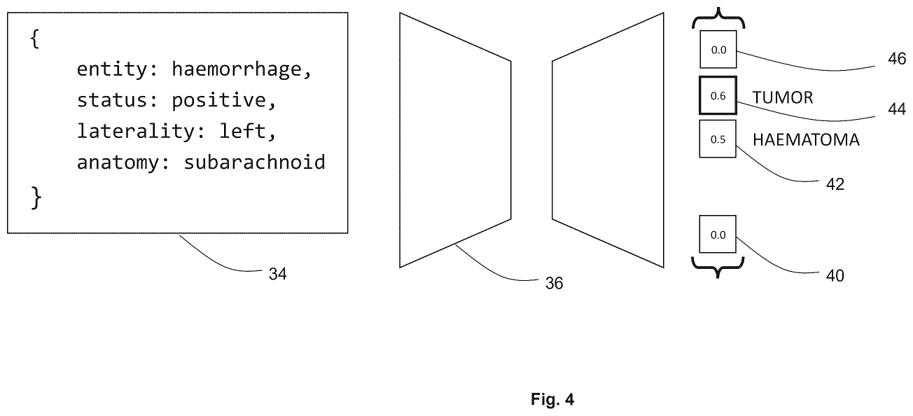

FIG. 4 shows further detail of some of the output tokens/labels 42, 44, 46, 48 available to the BART transformer 36 before a text output is generated and their corresponding conditional probabilities according to one embodiment.

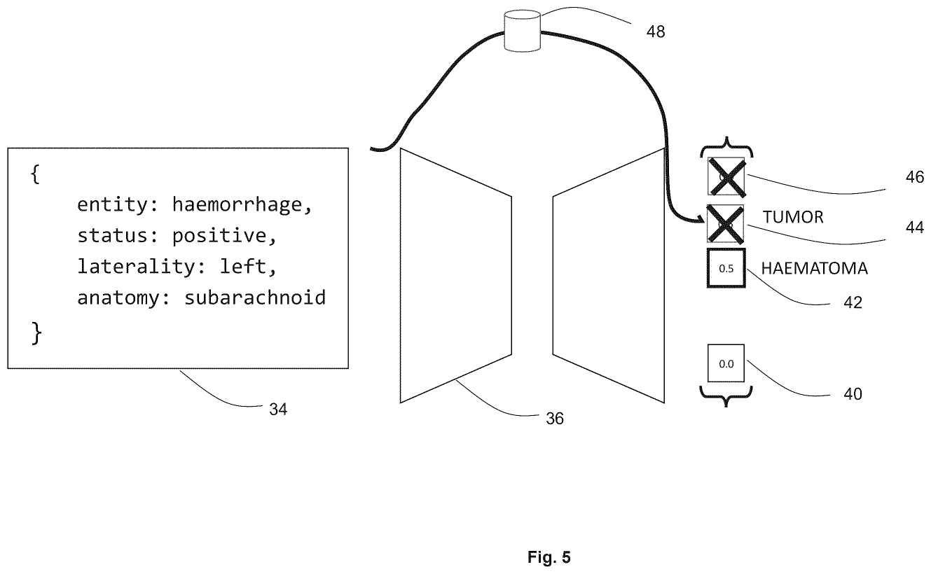

FIG. 5 shows further detail of an embodiment wherein the text input 34 is processed using process 48 to generate a list of labels that are precluded from the output. In the embodiment shown, the labels associated with output token/label 46 and output token/label 44 “Tumor” are removed from the list of output candidates.

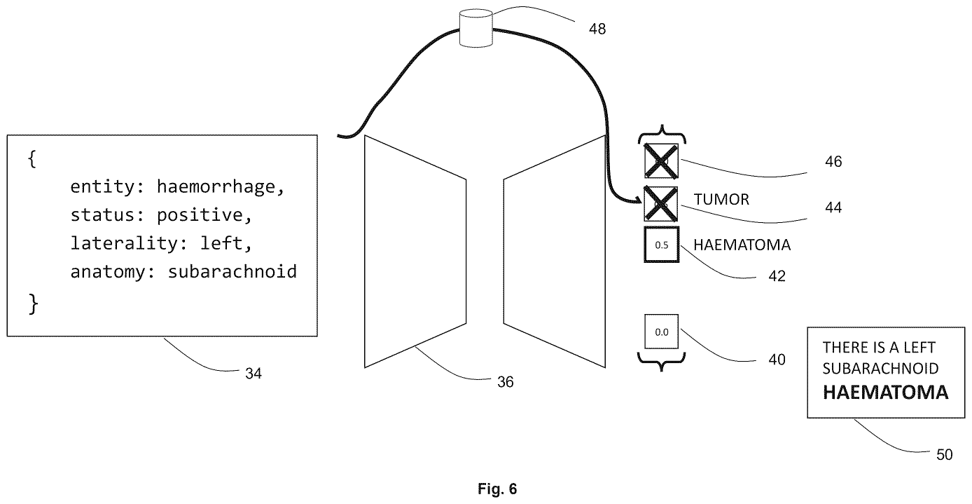

FIG. 6 shows further detail of an embodiment wherein the text input 34 is processed using process 48 to generate a list of labels that are precluded from the output. In the embodiment shown, the output token 44 ‘tumor’ is removed from the list of output candidates. The output text may no longer include the text ‘tumor’ without regard to its conditional probability. The output token 42 ‘hematoma’ is selected by the BART transformer 36 despite it having a lower conditional probability than ‘tumor’ and the output text 50 reads: “there is a left subarachnoid hematoma”.

Any suitable filtering may be performed to exclude candidate tokes that do not match the exclusion criteria. For example, the filtering may be such as to exclude or include tokens from the output text that related to particular diseases or other pathologies (e.g. a tumor or haemorrage), medical decisions or type of medical document, or that are inconsistent or consistent with such things.

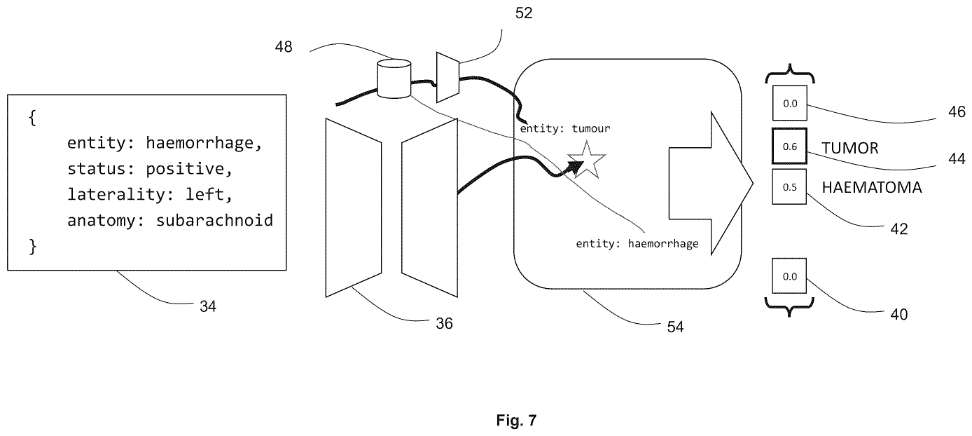

FIG. 7 shows an embodiment wherein the embedding space 54 of the BART transformer 36 is aligned with a new knowledge graph embedding. This allows the application of soft constraints via a loss function during the training phase of the machine learning model. In this embodiment, instead of using a database or UMLS graph, the word relation are included during the training of the Bart model with an additional loss that makes related terms close to each-other in the vector embedding space. As such the model would be less likely to include these incorrect relationships since they now have separation in the embedding.

A ‘contrastive loss’ term can be applied during training that punishes closeness to unfavorable tokens/labels and rewards closeness to favorable tokens/labels. A new loss term can be added to enforce consistency. If the output token generated is close in the aligned embedding space to the set of labels that are not synonyms or absent labels, the process is penalised to prevent the generation of the next generation.

The loss acts to minimise the distance between present entities and likely prediction.

A trained entity linking model (also referred to as entity linker) can be used to highlight occurrences of entities in text. In such a model, when multiple sequences with variety are generated by the sequence generator from the given input, the entity linker is used to determine which of the varying sequences are factually correct, so the incorrect sequences can be discarded.

Table 1 below shows experimental results of an embodiment of the invention, used to improve performance of rare labels (also referred to as macro scores) at the expense of common labels (also referred to as micro scores).

| | | Report | Report | | | | | | | |
|---|---|---|---|---|---|---|---|---|---|---|
| | Report | level | level | | | | | | | |
| | level | micro | micro | Macro | Macro | Macro | | | | |
| | micro_f1 | precision | recall | f1 | precision | recall | bleu | tp | fn | fp |
| unrestricted | 0.899 | 0.887 | 0.911 | 0.825 | 0.855 | 0.816 | 20.7 | 448 | 44 | 57 |
| restricted | 0.878 | 0.867 | 0.888 | 0.848 | 0.899 | 0.833 | 17.3 | 437 | 55 | 67 |

Precision = true positive/(true positive + false positives), Recall = true positives/(true positives + false negatives).
Macro is where we average the (for example) recall of each class. Macro Recall = Recall(class A) + Recall(class B) + Recall(class C)/3. For Micro recall one would add everything into one recall equation Micro Recall = (TpA (true positive for class A) + TpB + TpC)/(TpA + FnA + TpB + FnB + TpC + FnC). F1 score = (2 * Precision * Recall)/(Precision + Recall). Tp = true postive, fn = False negative, fp = False Positive.

To generate these result experimentally, a decoder restriction was applied to the Automated Reporting Radiology Report sentence generation model evaluation pipeline. In this case the model was trained on half of the available data to make an effect visible. The results are as determined by the labeler which is trained on the original dataset. If we force our model to generate outside that distribution, the labeller may perform worse.

The embodiments described are successful at removing convincing looking hallucinations. It is easy to add phrases manually to include in the output tokens precluded from the input. However, the text generator may be forced into probability spaces that it is weak in, so sentence quality may suffer slightly on some occasions. The use of this generator increases inference time based on the number and size of words to preclude, as each of the sequences to avoid is pre-tokenised and checked every time a new candidate token is about to be selected.

However, the use of the text generator does not require any changes to the training phase of the machine learning model. Hence, currently trained models can have such a modification applied to them.

According to certain embodiments there is provided an apparatus comprising processing circuitry configured to: receive input text; apply a trained model to the input text to determine a sequence of tokens, wherein the sequence of tokens represents a text output, wherein the trained model is configured to perform a repeating next token selection process comprising selecting a next token in the sequence based on at least one previous token in the sequence, the next token selection process comprises selecting a plurality of candidate tokens and the processing circuitry is configured to filter the plurality of candidate tokens to exclude one or more of the candidate tokens if they match at least one exclusion criterion.

The at least one exclusion criterion may be set based on the input text.

The at least one exclusion criterion may comprise a match with a banned list of items, wherein the banned list of items is determined based on the input text.

The banned list of items may comprise labels or tokens.

The processing resource may be configured to process the input text to select items that match or can be derived from the input text, and to generate the banned list of items based on items that do not match or are not derived from the input text.

The processing circuitry may be configured to identify a plurality of tokens or other text items from the input text and the selecting of items that match or can be derived from the input text comprises selecting items from a dictionary that match the identified plurality of tokens or other text items.

The selecting of items from the dictionary may include selecting synonyms for the identified tokens or other text items.

The processing circuitry may be configured to select items for the banned list of items from items in the dictionary that do not match or cannot be derive from the input text.

The generation of the banned list of items may comprises selecting items from a dictionary.

The processing circuitry may be configured to exclude one or more of the candidate tokens based on their distance to relevant or banned items in an embedding space.

The dictionary may comprise a set of medical terms and associated synonyms.

The processing resource may be configured to navigate a knowledge graph based on the input text thereby to obtain at least one context-specific sub-graph and to use the least one context-specific sub-graph to expand the banned list.

The input text may comprise at least one of text from physician notes, text from a medical record, or text associated with at least one scan, medical investigation or other medical procedure.

The banned list may represent at least one of a pathology, disease, medical condition or symptom.

The output text may represent at least one of a status of a patient, a medical condition, a diagnosis or a summary of at least one of physician notes, a medical record, or a description of outcome of a scan, medical investigation or other medical procedure.

The trained model may comprise an encoder-decoder model.

The trained model comprises a large language model (LLM) or other language model.

The model may comprise at least one of GPT-2, GPT-3.5, GPT-4, PaLM, LLaMa, BLOOM, Ernie, T5, Claude or Claude 2, or any suitable derivatives or developments thereof.

The dictionary may comprise or be derived from a hierarchical ontology.

The hierarchical ontology may comprise the International Classification of Disease (ICD), SNOMED CT, Radlex or other diagnostic code ontology.

Certain embodiments provide a computer-implemented method comprising: receiving input text; applying a trained model to the input text to determine a sequence of tokens, wherein the sequence of tokens represents a text output that is generated based on the input text, wherein the trained model is configured to perform a repeating next token selection process comprising selecting a next token in the sequence based on at least one previous token in the sequence, the next token selection process comprises selecting a plurality of candidate tokens and the processing circuitry is configured to filter the plurality of candidate tokens to exclude one or more of the candidate tokens if they match at least one exclusion criterion.

Certain embodiments provide a system comprising
a sequence generator that allows a computer to create a text string in response to an input string using a neural network decoder;
a relevant synonyms data store (e.g. dictionary, knowledge graph, ontology) that allows mapping from an input string to a collection of relevant strings;
a collection of labels, comprising the lookup keys of the relevant synonyms data store.

The system may provide a restriction step in which during the operation of the sequence generator, the restriction step runs when a new extension to the input string (e.g. an “output candidate”) is made, where the labels present in the input are used to create a set of labels that are not present in the input (e.g. “set of absent labels”), each item of which is expanded using the dictionary and collected to create a list of terms that should not appear in the output (e.g. “banlist”) such that the banlist is used when considering an output candidate and discarding the output candidate if present in the banlist producing the effect of reduced hallucinations and more faithful text.

The system may further comprise a knowledge graph or ontology that can be navigated to produce context specific subgraphs that can be used to extend the banlist to relevant specific terms. The system may use manual selections of text as a source for strictly relevant synonyms. The system may provide a step before the conversion of labels to the banlist where neighbouring semantic vector embeddings of the knowledge graph in a vector database are used to collect candidate tokens for the banlist. The or an output embedding space of the sequence generator may be aligned to the knowledge graph embedding space, for example such that if the candidate next generated token is close in the aligned space to the set of absent labels the probability is penalised to prevent generation of the next generation.

Certain embodiments provide a system comprising:
a sequence generator that allows a computer to create a text string in response to an input string using a neural network decoder; and
a knowledge graph of medical entities that can be used to extract synonyms for entities in the graph. The system may be configured such that during the training of the sequence generator, an additional loss term is used to align the representation space of the sequence generator with an embedding of the knowledge graph. For the training step, the labels present in the input may be used to create a set of labels that are not present in the input (e.g. “set of absent entities”). The loss may act to minimise the distance between present entities and likely prediction. The system may use a loss term to maximise a distance between likely predictions and items in the set of absent entities.

Certain embodiments provide a system comprising:
a sequence generator that allows a computer to create a text string in response to an input string using a neural network decoder; and
a collection of labels, comprising the entities of a knowledge graph or ontology.

The system may receive a n input to the sequence generator. A subset of the label collection may represent entities present in the given input. The system may include a trained entity linking model (“entity linker”) that can highlight occurrences of entities in text, for example such that when multiple sequences with variety are generated by the sequence generator from the given input, the entity linker may be used to determine which of the varying sequences are factually correct, for example the incorrect sequences can be discarded.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. An apparatus comprising processing circuitry configured to:
receive input text;
apply a trained model to the input text to determine a sequence of tokens, wherein the sequence of tokens represents a text output,
wherein the trained model is configured to perform a repeating next token selection process comprising selecting a next token in the sequence based on at least one previous token in the sequence,
the next token selection process comprises selecting a plurality of candidate tokens and the processing circuitry is configured to filter the plurality of candidate tokens to exclude one or more of the candidate tokens if they match at least one exclusion criterion.

2. An apparatus according to claim 1, wherein at least one exclusion criterion is set based on the input text or upon input tokens.

3. An apparatus according to claim 2, wherein the at least one exclusion criterion comprises a match with a banned list of items, wherein the banned list of items is determined based on the input text.

4. An apparatus according to claim 3, wherein the banned list of items comprises labels or tokens.

5. An apparatus according to claim 3, wherein the processing resource is configured to process the input text to select items that match or can be derived from the input text, and to generate the banned list of items based on items that do not match or are not derived from the input text.

6. An apparatus according to claim 5, comprising identifying a plurality of tokens or other text items from the input text and the selecting of items that match or can be derived from the input text comprises selecting items from a dictionary that match the identified plurality of tokens or other text items.

7. An apparatus according to claim 6, wherein the selecting of items from the dictionary includes selecting synonyms for the identified tokens or other text items.

8. An apparatus according to claim 6, wherein the processing circuitry is configured to select items for the banned list of items from items in the dictionary that do not match or cannot be derive from the input text.

9. An apparatus according to claim 5, wherein the generation of the banned list of items comprises selecting items from a dictionary.

10. An apparatus according to claim 6, wherein the dictionary comprises a set of medical terms and associated synonyms.

11. An apparatus according to claim 3, wherein the processing resource is configured to navigate a knowledge graph based on the input text thereby to obtain at least one context-specific sub-graph and to use the least one context-specific sub-graph to expand the banned list.

12. An apparatus according to claim 1, wherein the input text comprises at least one of text from physician notes, text from a medical record, or text associated with at least one scan, medical investigation or other medical procedure.

13. An apparatus according to claim 1, wherein the banned list represents at least one of a pathology, disease, medical condition or symptom.

14. An apparatus according to claim 1, wherein the output text represents at least one of a status of a patient, a medical condition, a diagnosis or a summary of at least one of physician notes, a medical record, or a description of outcome of a scan, medical investigation or other medical procedure.

15. An apparatus according to claim 1, wherein the trained model comprises an encoder-decoder model.

16. An apparatus according to claim 14, wherein the trained model comprises a large language model (LLM) or other language model.

17. An apparatus according to claim 14, wherein the model comprises at least one of GPT-2, GPT-3.5, GPT-4, PaLM, LLaMa, BLOOM, Ernie, T5, Claude or Claude 2, or any suitable derivatives or developments thereof.

18. An apparatus according to claim 9, wherein the dictionary comprises or is derived from a hierarchical ontology.

19. An apparatus according to claim 18, wherein the hierarchical ontology comprises the International Classification of Disease (ICD), SNOMED CT, Radlex or other diagnostic code ontology.

20. A computer-implemented method comprising:
receiving input text;
applying a trained model to the input text to determine a sequence of tokens, wherein the sequence of tokens represents a text output that is generated based on the input text,
wherein the trained model is configured to perform a repeating next token selection process comprising selecting a next token in the sequence based on at least one previous token in the sequence,
the next token selection process comprises selecting a plurality of candidate tokens and the processing circuitry is configured to filter the plurality of candidate tokens to exclude one or more of the candidate tokens if they match at least one exclusion criterion.
